(19) United States
(12) Patent Application Publication
(10) Pub. No.: US 2026/0219369 A1
(43) Pub. Date: Jul. 30, 2026

(54) LIGHT DEVICE FOR OBJECT DETECTION

(71) Applicant: VALEO VISION, Bobigny (FR)

(72) Inventors: Matheo GOURDON, Bobigny (FR); Mickael MIMOUN, Bobigny (FR); Hafid EL-IDRISSI, Bobigny (FR); Pierre RENAUD, Bobigny (FR); Sidahmed BEDDAR, Bobigny (FR); Geoffrey PIQUARD, Bobigny (FR)

(73) Assignee: VALEO VISION, Bobigny (FR)

(21) Appl. No.: 19/143,727

(22) PCT Filed: Dec. 22, 2023
(86) PCT No.: PCT/EP2023/087520

§ 371 Date: Jun. 26, 2025

(30) Foreign Application Priority Data
Dec. 29, 2022 (FR) FR2214675

(51) Int. Cl. G01S 7/484; G01S 7/481; G01S 17/931

(52) U.S. Cl. CPC G01S 7/484; G01S 7/4815; G01S 17/931

(57) ABSTRACT

One aspect of the invention relates to a light device for a motor vehicle. The light device includes a plurality of light modules that emit pulsed visible light, which is modulated by means of a high-frequency light code, each light module includes at least one driver circuit controlling multiple light-emitting diodes, and a device for receiving the light emitted by each of the light modules once the light has been reflected off an object, wherein each light-emitting diode is connected to the driver circuit by a conductive track, the conductive tracks connecting each of the light-emitting diodes to the driver circuit, each one of which light-emitting diodes includes the same length of conductive track to ensure synchronous control of the light-emitting diodes by the driver circuit. Another aspect of the invention relates to a driver assistance system for a motor vehicle, the system comprising at least one such light device.

### TECHNICAL FIELD

The present invention relates to a luminous device, for an automotive vehicle, suitable for object detection. The invention also relates to a driving assistance system for an automotive vehicle comprising this luminous device.

### BACKGROUND OF THE INVENTION

With the development of autonomous automotive vehicles, driving assistance means have greatly improved in recent years. One of the most useful assistance means is the assistance means for detecting pedestrians or objects in the environment of the vehicle.

Devices for detecting the presence of pedestrians or objects in the environment of the vehicle, simply called object detection devices, are known. These devices generally use what is known as lidar (light detection and ranging) technology, which is based on analyzing the properties of a light beam, generally a laser beam, emitted by a specific light source and reflected by the object. With lidar technology, the distance between the light source and the object is measured based on the time lag between the emission of a laser pulse and the reception of the reflected pulse. An object detection device using a lidar is relatively simple to implement because the light source emits a single high-power infrared signal that bounces back off the object; the time of flight of the infrared signal is measured when said signal is received by a sensor. However, such an object detection device requires specific equipment to emit the infrared signal and to receive the bounced-back signal.

In order to ensure a detection rate and/or false-positive rate in line with the standard, complementary technologies are required. For this purpose, three assistance devices based on different technologies are generally combined with one another; the data generated by these various assistance devices are cross-checked and final data are generated to inform the driver, or the vehicle itself in the case of an autonomous vehicle, of the presence of a pedestrian or object in the environment of the vehicle. However, the addition of three distinct devices in one and the same zone of the vehicle places load on a zone upon which high demands are already placed in terms of crowding.

To address crowding problems, it has been envisaged to carry out object detection using the lighting that is already present on the vehicle, such as the daytime running lights of the vehicle. However, the light source of modern luminous devices is generally a set of light-emitting diodes, controlled from a driver circuit. Now, light-emitting diodes (LEDs) in vehicle luminous devices emit visible light continuously, thereby making the light difficult to detect after reflection from the object, in particular because it is combined with natural sunlight, light from street lamps and light from other outdoor light sources. To facilitate the detection of light emitted by the LEDs and reflected by the object, it has been envisaged to modulate the light; the light beam emitted by the LEDs is then pulsed and modulated by a high-frequency code. However, to be effective, and therefore detectable, the modulation of the light beam must be precise; the LEDs forming the light source must therefore all emit their light ray simultaneously so as not to generate interference. Now, the current trend is to deploy LEDs, in rows, in layers or in grids, to achieve style effects, which means that some of them are moved away from the driver circuit that controls them; the fact that the LEDs are closer to or further away from the driver circuit causes a time lag in the emission of the light ray from some LEDs compared to others. Said lag causes the emissions of signals to be spread over time, which has two consequences. First of all, this lag at emission is carried over to the signal that has been reflected from an object, and which is retransmitted to a sensor present on the vehicle. It is therefore more difficult to determine the time lag between the emission of a light pulse and the reception of the reflected pulse. Second of all, the spread of the pulses degrades the signal-to-noise ratio. Indeed, all other things being equal, the intensity of a simultaneous pulse is detected more easily at the sensor than the intensity of a plurality of emissions spread over time.

### SUMMARY OF THE INVENTION

In order to address the abovementioned problems with interference and with time lag in emission by the LEDs, the applicant provides a luminous device configured for object detection, in which all the LEDs are connected equidistantly from the driver circuit controlling them.

According to a first aspect, the invention relates to a luminous device for an automotive vehicle, comprising:
at least one luminous module emitting pulsed visible light modulated by means of a high-frequency luminous code, each luminous module comprising at least one driver circuit supplying with electricity via the same driver-circuit output a plurality of light-emitting diodes, said driver circuit being configured so as to modulate, in accordance with the high-frequency code, an electric power received by the light-emitting diodes in order to emit the pulsed visible light, and
a reception device for receiving the light emitted by the at least one first luminous module, for receiving some of the pulsed light, modulated in accordance with the code, after reflection of the pulsed light emitted by the at least one first luminous module from an object outside the vehicle,

wherein:
the modulation frequency is greater than 10 MHz, and
each light-emitting diode is connected to the same output of the driver circuit by a conductor track, the conductor tracks connecting each of the light-emitting diodes to the driver circuit each having an impedance ensuring the same phase shift at the modulation frequency for all the LEDs, thus ensuring synchronous modulation of the electric power perceived by the light-emitting diodes supplied by the driver circuit.

For the transmission of high-frequency signals, the characteristics of the conductor tracks, such as their length, their width, their thickness and the shapes of any bends, influence their impedance and consequently the phase shift and therefore the delay of the signal perceived by an LED connected to the track.

Light-emitting diodes (LEDs) are understood to mean light-emitting sources that emit incoherent light, as are known for being well suited to use for signaling or lighting luminous devices for automotive vehicles, as opposed to laser sources (including laser diode sources). Indeed, laser sources emit temporally and spatially coherent light, and have the drawback of posing risks for eye safety, meaning they have to be controlled using complex and expensive means.

Indeed, a device suitable for implementing a DRL/PL function makes it possible to implement a detection function using a majority of the LEDs necessary for the signaling function. A majority is understood to mean more than 50% of the LEDs assigned to the function transmit the code, preferably more than 75%, preferably all of the LEDs transmit the code. This is particularly relevant when the LEDs are similar in terms of flux emission characteristics and activation current. Since the majority of the LEDs contribute to the signaling function illuminating objects located in front of the automotive vehicle, the detection of the pulsed light from the LEDs is thereby not disturbed by the detection of non-pulsed light emitted by the same function. This improves a signal-to-noise ratio of the reception of the luminous code by the sensor.

As an alternative, if the luminous function is implemented by dissimilar LEDs, it is advantageous for LEDs representing more than 50% of the luminous flux attributed to the function to transmit the code, preferably more than 75% of this flux, preferably all of this flux.

Similarly, it is advantageous to implement lighting functions such as low beam and high beam with light-emitting diodes whose supply of electric power is modulated at high frequency to transmit the code. Multiple light-emitting diodes are usually used to produce the low beam and the high beam, sometimes within one and the same luminous module, for example a dual-function luminous module. It is then preferred to use at least one driver circuit capable of modulating, at high frequency, the supply of power to the LEDs of a sector grouping together first LEDs necessary for the low beam function, in accordance with the code, and a driver circuit capable of modulating, at high frequency, the supply of electric power to the second LEDs of a sector grouping together LEDs necessary for the high beam function, in accordance with the same code, in a manner synchronized with the supply of electric power to the sector of the first LEDs. In another example, the high beam function and/or the low beam function comprise individually activatable and deactivatable LEDs, for example in order to emit a partial high beam in which some lighting zones are activated or deactivated, or, as an alternative or in addition, a low beam in which some LEDs corresponding to a light cut-off are activated or deactivated so as to move a central zone of a cut-off zone horizontally in relation to the vehicle when the luminous device is installed on the vehicle, and thus to implement a directional low beam function, known as a DBL (dynamic bending light). Since the majority of the LEDs emit pulsed light modulated in accordance with the code, the detection of the pulsed light from the LEDs is thereby not disturbed by the detection of non-pulsed light emitted by the same function. This improves a signal-to-noise ratio of the reception of the luminous code by the sensor.

With a connection of same impedance between the driver circuit and all the light-emitting diodes that it controls, the luminous module of this luminous device is capable of emitting a synchronous light beam, without risk of interference. The luminous device according to the invention is thus suitable for object detection.

Besides the features that have just been outlined in the previous paragraph, the luminous device according to one aspect of the invention may have one or more additional features from among the following, which may be implemented individually or in any technically feasible combination:
the impedance of the conductor tracks is such that the driver circuit and the light-emitting diode furthest from said driver circuit perceive the modulation of the electric power with the same delay, the conductor tracks of the light-emitting diodes closest to the driver circuit forming delay lines;
the length of the conductor tracks is equal to the length of the track between the driver and the light-emitting diode furthest from said driver;
the conductor tracks, the light-emitting diodes and the driver circuit are mounted on the same substrate;
the substrate is a rigid PCB substrate, for example a rigid FR4 substrate, a flexible PCB substrate, for example a flexible polyimide-containing substrate, or an IMS (IMS standing for Insulated Metal Substrate, comprising a metal base on which an insulator and at least one conductive layer capable of forming tracks are laminated), for example an IMS the base of which is made of aluminum;
the reception device comprises at least one light sensor and one blue-light optical filter, the filter preferably being configured to let pass only a wavelength band corresponding to a main band of the emission spectrum of the LEDs, and to exclude wavelengths at which the LEDs emit weakly or do not emit, for example wavelengths at which the LEDs emit at less than 50% of the intensity emitted at their maximum;
the receiving device comprises a computing unit for comparing, in particular by correlation, the modulation of the received part of the pulsed light with the modulation of the emitted pulsed light, and thus determining a time of flight of modulated pulsed light waves from the luminous module to the object so as to provide a measurement of distance between the object and the luminous device.

A second aspect of the invention relates to a driving assistance system for an automotive vehicle, characterized in that it comprises at least one first and one second luminous device according to the first aspect, which devices are combined with one another for the purpose of detecting one and the same object.

A third aspect of the invention relates to a driving assistance system for an automotive vehicle, characterized in that it comprises at least one first device for detecting an object in the environment of the automotive vehicle, the luminous device according to the first aspect constituting a second object detection device that provides redundancy for the first object detection device.

### BRIEF DESCRIPTION OF THE DRAWINGS

Other advantages and features of the invention will become apparent on reading the following description, which is illustrated by the figures, in which:

FIG. 1 schematically shows one example of a vehicle equipped with luminous devices according to the invention;

FIG. 2 schematically shows one example of modulated light pulses emitted by a luminous device according to the invention; and

FIG. 3 schematically shows one example of three LEDs connected to a driver circuit according to the invention.

In the figures, identical elements have been identified using identical reference signs. For the sake of the readability of the figures, the elements in the figures have not been shown scale.

### DETAILED DESCRIPTION OF THE INVENTION

One exemplary embodiment of a luminous device according to the invention is described in detail below, with reference to the appended drawings. This example illustrates the features and advantages of the invention. However, it will be recalled that the invention is not limited to this example.

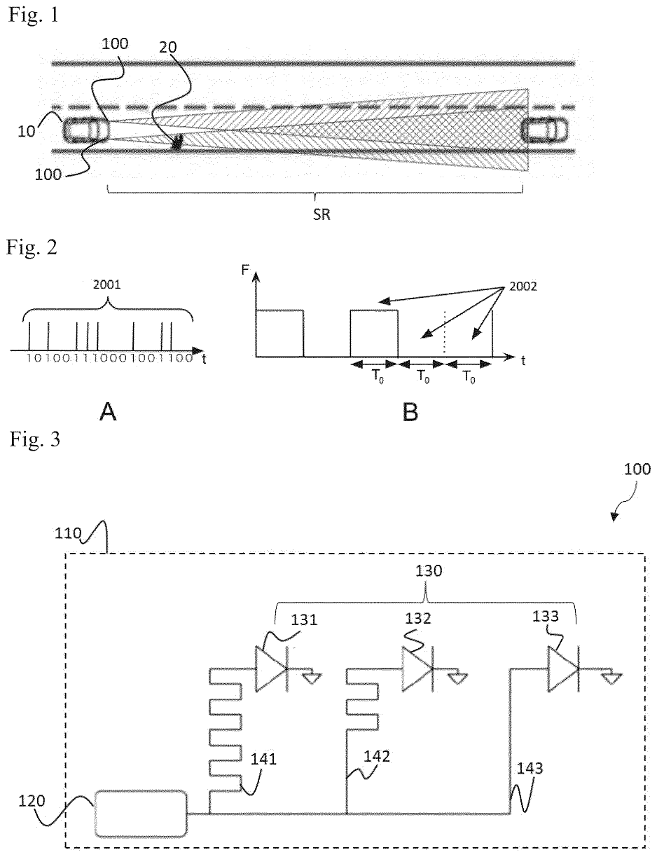

One example of an automotive vehicle 10 equipped with two luminous devices 100 according to the invention is shown in FIG. 1. This example shows a pedestrian 20 crossing in front of the vehicle 10. The vehicle 10 is equipped with two luminous devices 100, for example daytime running lights, which illuminate the road scene SR ahead of the vehicle. The luminous devices 100 are integrated into a driving assistance system, using which the pedestrian 20 is able to be detected.

The luminous device 100 according to the invention may be any basic lighting device present on a vehicle. The luminous device 100 may for example be a daytime running light, a position light, a signaling light, a side light strip, a front light grid or any other external lighting means customarily integrated on a vehicle to allow it to be seen on the road; the luminous device is then used to detect pedestrians or objects on the road scene or in the external environment of the vehicle. The luminous device may also be a lighting device inside the vehicle; it may then be used to detect objects or people inside the vehicle.

The luminous device 100 is used to emit pulsed light modulated by a high-frequency luminous code. This luminous code is a binary cyclic code composed of a succession of 1s and 0s, the 1s corresponding to a pulse, the 0s corresponding to no emission of light. The light beam emitted by the LEDs contained in the luminous device is modulated so as to transmit the luminous code. The LEDs thus emit a succession of light pulses with a duration of about 10 to 20 ns, this corresponding to a high frequency of modulation of the supply of electric power to the LEDs from 10 MHz to 400 MHz, preferably 30 MHz to 200 MHz, preferably 50 to 100 MHz. One example of a code 2001 is shown in part A of FIG. 2, and one example of light pulses 2002 having a period TO corresponding to this code is shown in part B of FIG. 2. It should be noted that, by emitting a light beam modulated by this code at high frequency, the human eye does not perceive this modulation. For the human eye, the light beam is continuous and the luminous code is invisible. The luminous code emitted via the modulation of the light beam may therefore be utilized for object detection.

As explained above, and as schematically shown in FIG. 3, a luminous device 100 comprises a plurality of luminous modules 110 that each comprise one driver circuit 120 and a plurality of white LEDs 130. The LEDs 130 of a given module are connected to the same driver circuit 120. A driver circuit 120, also called a driver, is an item of equipment for supplying DC current to the LEDs to which it is connected. Thus, a driver circuit 120 controls a plurality of LEDs 130, three in the example of FIG. 3.

In the example of FIG. 3, the three LEDs 131, 132, 133 connected to the driver circuit 120 are positioned at different distances from the driver circuit 120. In order for the light beam emitted by the luminous module 110 to be modulated precisely, the three LEDs 131, 132, 133 of the luminous module 110 must emit their light beams simultaneously. For this purpose, each of the three LEDs 131, 132, 133 is connected to the driver circuit 120 by a conductor track, 141, 142, 143, respectively; these conductor tracks 141, 142, 143 are all of the same length. The length of the conductor tracks is determined as a function of the LED furthest from the driver circuit. Indeed, all of the conductor tracks 141, 142, 143 have a length equal to the length of the conductor track 143 for connecting the driver circuit 120 to the LED furthest from said driver circuit, namely LED 133 in the example of FIG. 3. The conductor track 143 connecting the LED 133 to the driver circuit 120 is therefore a conventional conductor track. The conductor tracks 141 and 142 connecting the driver circuit 120 to LEDs 131 and 132, which are the LEDs closest to the driver circuit, form delay lines. All of the LEDs of one and the same luminous module are thus connected equidistantly from the driver circuit that supplies them.

The distance between the driver circuit and an LED is a physical distance, that is to say a “point-to-point” length determined between the control output of the driver circuit and the input terminal of the LED. The concept of “furthest (away)” should therefore be understood in terms of physical distance, the LED furthest from the driver circuit being the LED whose distance from the driver circuit is greatest compared to the distances of the other LEDs from the driver circuit. Similarly, the concept of “closest” should be understood in terms of physical distance, the LED closest to the driver circuit being the LED whose distance from the driver circuit is shortest compared to the distances of the other LEDs from the driver circuit.

Thus, in a luminous device according to the invention, the physical distance between a driver circuit 120 and the LEDs 130 that it controls may vary, while the connection distance between this driver circuit 120 and these LEDs 130 is identical.

In other words, since all of the conductor tracks are of the same length, the conductor tracks 141, 142 of the LEDs closest to the driver circuit comprise loops and/or detours that make it possible to generate the delay lines. Thus, when the driver circuit 120 transmits a light ray emission command, the control signal transmitted by the driver circuit 120 is received simultaneously by all of the LEDs connected to the driver circuit. The LEDs therefore emit their light ray at the same time, in synchronized fashion. The light beam emitted by the luminous module 110 is therefore synchronous, thereby ensuring efficient modulation of the light beam with all of the light rays of the LEDs of the module simultaneously emitting the same bit of the code.

The LEDs, the driver circuit and the conductor tracks are formed on a substrate. Irrespective of whether they are conventional or form a delay line, the conductor tracks are produced on the substrate in the same way as any other conductor track, only the length of the track possibly varying.

In certain luminous devices 100, a single substrate bears all the LEDs and the driver circuit of a given module. In other words, all the LEDs and the driver circuit are produced on the same substrate, for example a flexible or rigid PCB (PCB being the acronym of Printed Circuit Board) substrate or an IMS (IMS being the acronym of Insulated Metal Substrate). The conductor tracks 141-143 are therefore formed in one and the same substrate. In other luminous devices 100, a luminous module 110 may be formed on at least two substrates connected to each other by connectors, for example pin-, tab- or jaw-based connectors. In this case, all or only some of the conductor tracks 141, 142, 143 may extend over both substrates; the length of the conductor tracks may be determined taking into account the delay induced by the connection between the two substrates.

The luminous module 110 as has just been described makes it possible to emit a modulated light beam synchronously. To enable object detection, this luminous module is associated with a reception device for receiving the light beam reflected by the object (not visible in the figures). This reception device is integrated into the luminous device 100 of the invention. It makes it possible to receive light beams after they have been reflected by the object that it is sought to detect. This reception device comprises a light sensor or a set of light sensors; these one or more sensors may for example be photon counters, preferably avalanche diodes. The photon counters are preferably distributed over one and the same high-density substrate, preferably so as to constitute a detection matrix. The sensor is preferably associated with a blue-light optical filter, that is to say a bandpass filter designed to capture only light with a blue wavelength and suppress all other wavelengths. Indeed, white LEDs suitable for signaling comprise a light-emitting chip that emits blue light and to which there is applied a phosphor suitable for transforming a portion of the blue light into yellow light, the mixture of untransformed blue light emitted by the chip and yellow light transformed by the phosphor resulting in white light. Similarly, amber LEDs suitable for signaling comprise a chip that emits blue light and to which a suitable phosphor is applied. The blue-light optical filter makes it possible to separate the blue light, corresponding to the majority of the light beam, in particular corresponding to the emission line of the light-emitting chip, emitted by the luminous module 110 and reflected by the object 20, from the rest of the spectrum of light coming from the sun or from any other external light sources emitting light in the visible range in the environment of the vehicle. The signal-to-noise ratio of the detection is thereby greatly improved.

This reception device is connected to a computing unit, which is installed in the luminous device or housed in any other location of the vehicle, preferably installed directly on the sensor, which determines the time of flight of the light beam and deduces therefrom a measurement of the distance between the vehicle and the detected object. The time of flight is the propagation time of the waves of the light beam emitted by the luminous module 110 in the environment, that is to say the time needed for the light beam to propagate to the object and return to the reception device. The distance between the object and the vehicle is determined from this time of flight. It should then be understood that the fact that the light beam is emitted by the luminous module 110 synchronously makes it possible to improve the determination of the time of flight. It should also be understood that the “object detection” function may be implemented by the luminous device 100 in parallel with its standard lighting function.

The luminous device 100 as has just been described may be used alone for object detection, in particular if the luminous device is a lighting device inside the vehicle.

The luminous device 100 may also be used in combination with another similar luminous device. The two luminous devices 100, for example the two front lighting devices of the vehicle, may be combined with one another for the purpose of detecting one and the same object.

The luminous device 100 may also be integrated into a driving assistance system for an automotive vehicle. Indeed, driving assistance systems generally require a combination of two or even three distinct object detection devices, that is to say operating using different technologies. These object detection devices should be complementary. The luminous device according to the invention may constitute one of these object detection devices. It has the advantage of using a specific technology that has not yet been used, since it carries out object detection by way of a light beam in the visible range. It has the additional advantage of not adding to mass and crowding, since it uses a lighting device that is already present on the vehicle. Moreover, it has the advantage of being able to be implemented on multiple lighting devices of the same vehicle (for the purpose of detecting objects in one and the same zone of the vehicle or in different zones), without the risk of interference, simply by choosing a different luminous code for each of the luminous devices used.

Although described by way of a certain number of examples, variants and embodiments, the luminous device according to the invention comprises various variants, modifications and improvements which seem obvious to those skilled in the art, it being understood that these variants, modifications and improvements form part of the scope of the invention. For example, on reading the present application, those skilled in the art will understand that it is easy to apply the principles thereof to other luminous devices from outside the automotive vehicle, for example rear signaling lights of the automotive vehicle.

What is claimed is:

1. A luminous device for an automotive vehicle, comprising:
at least one luminous module emitting pulsed visible light modulated by means of a high-frequency luminous code, each luminous module includes at least one driver circuit supplying with electricity via the same driver-circuit output a plurality of light-emitting diodes, the driver circuit being configured so as to modulate, in accordance with the high-frequency code, an electric power received by the light-emitting diodes in order to emit the pulsed visible light, and
a reception device for receiving the light emitted by the at least one first luminous module, for receiving part of the pulsed light, modulated in accordance with the code, after reflection of the pulsed light emitted by the at least one first luminous module from an object outside the vehicle,
wherein:
the modulation frequency is greater than 10 MHz, and
each light-emitting diode is connected to the same output of the driver circuit by a conductor track, the conductor tracks connecting each of the light-emitting diodes to the driver circuit each having an impedance ensuring the same phase shift at the modulation frequency for all the LEDs, thus ensuring synchronous modulation of the electric power perceived by the light-emitting diodes supplied by the driver circuit.

2. The luminous device as claimed in claim 1, wherein the impedance of the conductor tracks is such that the driver circuit and the light-emitting diode furthest from the driver circuit perceive the modulation of the electric power with the same delay, the conductor tracks of the light-emitting diodes closest the driver circuit forming delay lines.

3. The luminous device as claimed in claim 2, wherein the length of the conductor tracks is equal to the length of the track between the driver and the light-emitting diode furthest from the driver.

4. The luminous device as claimed in claim 1, wherein the conductor tracks, the light-emitting diodes and the driver circuit are mounted on the same substrate.

5. The luminous device as claimed in claim 1, wherein the substrate is a rigid PCB substrate, a flexible PCB substrate or an IMS.

6. The luminous device as claimed in claim 1, wherein the receiving device includes a computing unit for comparing the modulation of the received part of the pulsed light with the modulation of the emitted pulsed light, and thus determining a time of flight of modulated pulsed light waves from the luminous module to the object so as to provide a measurement of distance between the object and the luminous device.

7. The luminous device as claimed in claim 1, wherein the reception device includes at least one light sensor and one blue-light optical filter.
